(19) United States
(12) Patent Application Publication
(10) Pub. No.: US 2005/0220590 A1
(43) Pub. Date: Oct. 6, 2005

(54) Lifting and moving apparatus

(76) Inventor: William Mark Adams, Sutton cum Lound (GB)

Correspondence Address: GRADY K. BERGEN, 3333 LEE PARKWAY, SUITE 600, DALLAS, TX, 75219, US

(21) Appl. No.: 11/017,250

(22) Filed: Dec. 20, 2004

(30) Foreign Application Priority Data
Dec. 23, 2003 (GB) 0330005.0

(51) Int. Cl. B60P 1/02

(52) U.S. Cl. 414/495

(57) ABSTRACT

The invention relates to apparatus for the movement of goods in a goods storage area or areas. In one embodiment the goods storage area is or includes the interior of a goods storage trailer for a vehicle. The apparatus is provided with a body and includes at least one platform which can be movable in a substantially vertical direction. Wheels are provided on the apparatus body to allow movement of the apparatus along the floor of the goods storage area. The apparatus is of a width such that the same substantially extends across the width of the good storage trailer so as to allow access from the platform to all of the goods storage trailer interior for the loading and unloading goods via the platform.

This application claims foreign priority benefits under 35 U.S.C. §119(a)-(d) to British Patent Application No. 0330005.0, filed Dec. 23, 2003.

The invention to which this application relates is to an apparatus for the lifting and moving of goods, said apparatus of the type which can be used for the movement of goods between first and second positions in a goods storage area or areas. In particular, although not necessarily exclusively, the apparatus is for use in conjunction with the unloading and loading of goods to and from and in a goods storage area in the form, typically, of a goods storage trailer for a vehicle of the type which is used to transport goods from, for example, a warehouse, to retail premises.

The provision of apparatus for the improvement of loading and unloading operations in terms of efficiency, reduction of damage to the goods and reduction of risk of injury to operators using the apparatus, is known. The applicant has granted patents in respect of apparatus which is provided within a goods storage trailer and mounted thereto as part of the trailer such that there is provided at least one base upon which goods and/or an operator can stand and which base can move along guide means mounted on the side walls of the trailer. A problem with this form of device is that while efficient and usable within certain trailers having rigid side walls, the device is permanently fixed with respect to the same and therefore there is no possibility of the apparatus ever being used separately from the trailer which can limit the usage of the same. A further problem can be that the walls of the trailer to which the guide means are affixed can be caused to bow or become out of line by the guide means and the weight carried along the same. A further problem is that if the trailer which the platform is mounted is partially exposed to sunlight the guides and platform can become jammed which can lead to “crabbing” and subsequent jamming of movement of the platform and/or the apparatus along the trailer. This form of apparatus is also difficult to provide powered movement on and the required apparatus can take up valuable storage space. A yet further problem is that the apparatus is required to be fitted in and permanently positioned on a particular “bespoke” trailer. This can lead to trailer rental companies being unwilling to fit the apparatus as it thereafter restricts the trailer for a specific use and purposes which some customers may not want.

The applicant also has a patent granted in respect of lifting and moving apparatus for use typically in warehouse environments. However, such apparatus tends to be relatively small in size and therefore it has been found that the use of such apparatus to move large quantities of goods can be.

The aim of the present invention is to provide apparatus for use in the movement of goods between first and second positions with the apparatus being capable of use externally of a goods storage trailer and internally of the same so as to allow, if required, goods to be moved from a goods storage area location externally of a vehicle and also within a goods storage trailer for loading or in the reverse direction for unloading.

In a first aspect of the invention, there is provided apparatus for use in the movement of goods between first and second locations in a goods handling area or areas, said apparatus including a body with at least one platform movable in a substantial vertical direction, drive means for driving movement of the platform, said drive means and/or guide means acting as a guide for the movement of the platform, and wheels or rollers provided to allow movement of the apparatus across the floor of the goods storage area, the goods storage area comprising or including the interior of a goods storage trailer thereby allowing goods to be moved from an external location to within the trailer and/or within the trailer via said apparatus and wherein the platform extends substantially across the width of the interior of the goods storage trailer.

Typically, the width of the apparatus is such that the side walls or faces of the apparatus, when the apparatus is positioned within the vehicle trailer, lie adjacent to the interior faces of the side walls of the trailer. However, typically the width is less than the width of the opening into the storage area.

In one embodiment, the side walls or faces of the apparatus are provided with one, or more typically a series of, members which are provided to contact with the side walls of the storage area so as to maintain movement of the apparatus along the length of the storage area and thereby prevent the same from becoming snagged or jammed on the walls of the storage area. In one embodiment the members are rollers or skid members which extend outwardly from the side walls of the apparatus. With the provision of the members, the movement of the apparatus along the storage area is substantially in line with the longitudinal axis of the storage area and the members prevent jamming of the apparatus with respect to the side walls of the storage area.

Typically, movement of the apparatus along the surface is via a series of wheels, said wheels located so that the same do not protrude beyond the area of the apparatus in plan.

In one embodiment, at least one of the wheels is powered so as to allow an operator of the apparatus to control movement of the same along the storage area and externally of the storage area without having to manually move the same. In one embodiment the drive motor and drive means are controllable by the operator via a control means.

In one embodiment, the wheels are mounted as to allow linear movement in one direction and therefore each of the wheels are provided for movement in a linear direction. Alternatively, at least some of the wheels are mounted in a manner to allow the same to pivot and thereby provide directional steerage for the apparatus but in many uses the need for this will not be necessary. In one embodiment the apparatus is acceptable in two user selectable modes, a first mode where the wheels are fixed to move along a linear path and a second mode wherein at least some of the wheels are pivotal to allow steerage. The apparatus in the first mode is particularly suited to use when the apparatus is in the goods storage trailer as, once aligned, the movement of the apparatus subsequently along the length of the trailer is controlled. In the second mode the apparatus can be steered thereby making the same more usable in a less confirmed environment. In one embodiment the change between operating modes is achieved by the engagement of locks on those wheels which are pivotable, for the first mode, and release of the locks for the second mode.

Typically, the side walls of the apparatus incorporate therein lifting means, such as columns, which act as guide means for the vertical movement of the base on which the goods to be moved are loaded. Preferably, the lifting of the base is controlled by hydraulic ram, typically, one hydraulic ram being provided at each side wall and connected to claws or pulleys on which the platform is suspended.

Thus, in use, the apparatus can be used internally of the goods storage trailer to move goods within the trailer, as required and, once the loading and unloading operation has been completed in the trailer, the apparatus can either be removed from, or stored in the trailer, so that the apparatus does not impact on the storage capacity of the trailer, if that is of concern. In one embodiment therefore, the apparatus can be retained at a warehouse location and simply moved in and out of goods storage trailers as and when they arrive at the location. Alternatively, the apparatus can be transported along with the goods storage trailer and, at a loading and unloading location, used as required, either internally of the trailer or externally of the same.

In one embodiment the goods storage trailer has a floor, end wall, roof, elongate side walls and when the side walls are substantially rigid, a further end wall with an opening therein and through which goods and the apparatus can be moved. In an alternative embodiment when the goods storage trailer has side walls formed by flexible curtains of material which can be selectively moved between an open position and a closed position to allow the movement of goods and the apparatus therethrough, the further end wall does not have an opening. The apparatus in accordance with the invention can be used in either form of goods storage trailer as the apparatus does not rely on the side walls of the storage trailer for support or guidance and therefore the side walls of the trailer can be provided open or of flexible sheet material.

In a preferred embodiment the wheels are movable between an in use position in which the same contact with the goods storage area floor to allow movement of the apparatus, and a retracted position, in which case the underside of the body of the apparatus contacts the floor to act to retain the apparatus in a fixed position with the wheels out of contact with the floor. In one embodiment the wheels are mounted on cartridges which in turn are mounted on the body of the apparatus, with the cartridge movable typically in response to the operator control means via hydraulic rams, with respect to the apparatus body between in use and retracted positions. Preferably the platform cannot be moved on the apparatus until the wheels are moved to the retracted position.

In a preferred embodiment the apparatus is a self contained unit within the goods storage trailer. By self contained is meant that the apparatus does not need to be suspended or otherwise mounted to the goods storage trailer walls or roof. Thus, the wheels of the apparatus allow the movement of the apparatus along the trailer and the width of the platform and/or apparatus is sufficiently close to the width of the goods storage trailer to provide guidance without the need for physically mounting the apparatus on the trailer body. The apparatus is therefore independently usable and controllable and therefore can be used separately from the goods storage area or trailer.

Although it is preferred that the width of the platform is such as to extend across substantially the width of the goods storage trailer, it is possible that other features of the apparatus as herein described can be utilised with a platform which does not extend across the width and therefore it should be appreciated that these are protectable as separate features herein.

### BRIEF DESCRIPTION OF THE DRAWINGS

Specific embodiments of the invention are now described with reference to the accompanying drawings, wherein:

FIGS. 1a-c illustrate a plan elevation and side elevation views of the apparatus in accordance with one embodiment of the invention;

FIGS. 2a-d illustrate the use of the apparatus in the loading and unloading of goods in a vehicle trailer in accordance with one embodiment of the invention;

FIGS. 3a-b illustrate perspective views of the apparatus in one embodiment;

FIGS. 4a-d illustrate a further embodiment of the invention; and,

FIG. 5 illustrates the apparatus of FIGS. 4a and b in position in a good storage trailer in accordance with one embodiment.

### DETAILED DESCRIPTION

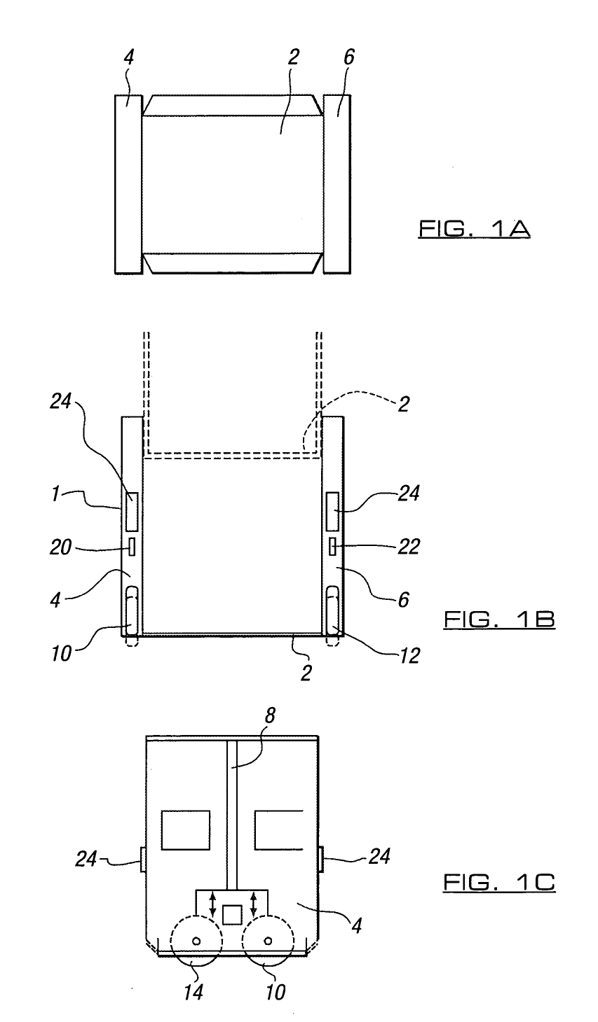

Referring firstly to FIGS. 1a-c and 3a-b there is illustrated apparatus 1 in accordance with the invention which comprises a body or frame with platform 2 mounted with respect to lifting columns, 4, 6 as part of or forming the side walls of the apparatus. Within each of the side walls 4, 6, is provided a hydraulic ram 8 and the hydraulic ram contacts with the platform 2 to control the movement of the same in a vertical direction to allow the adjustment of the height of the platform. As only two rams we provided so the synchronisation of the same can be reliably achieved. At the base of the apparatus are provided four wheels, 10, 12, 14, 16. These wheels are all positioned within the envelope formed by the area of the apparatus in plan as shown so that the same do not protrude beyond the apparatus side walls or front or back walls.

Typically, the wheels are movable between a retractable storage position in which the base of the apparatus contacts the surface to provide secure mounting of the same, and a protruding, in-use position as shown in FIG. 1c whereupon the wheels are used to move the apparatus as required. This movement is achieved by hydraulic means with the hydraulic rams 8 mounted above the hydraulic workings to minimise space wastage.

Preferably, the movement of the wheels between the retracted and protruding positions is powered. Further preferably, at least one of the wheels is powered when in the protruding position for rotation so as to allow the drive and movement of the apparatus. This allows the control of the apparatus, with the platform being powered, the wheels being powered, to be controlled by suitable control means by an operator and therefore it does not require the manual operation of the apparatus by the operator thereby minimising the risk of injury to the same. However, if any manual movement or manoeuvring is required, handles 20, 22 are provided. In order to allow control of the platform movement drive means and the apparatus wheel drive motor control means are provided for the operator on the apparatus and/or in communication with the apparatus. Electrical power can be received from batteries mounted on the apparatus or via a connection to an external power source.

As the apparatus moves along a goods storage area in the form of a vehicle trailer, a series of members, in this case in the form of rollers 24 are provided on the side walls of the apparatus with said rollers protruding outwardly from the side walls with a view to lying in contact with or adjacent to the side walls of the goods storage area. The rollers are positioned to at least partially fill the gap between the side walls of the apparatus and the internal faces of the side walls of the goods storage area. This therefore means that there is little opportunity for the apparatus to become jammed with respect to the side walls of the goods storage area and ensures that the apparatus remains aligned in its movement along the longitudinal axis of the goods storage trailer.

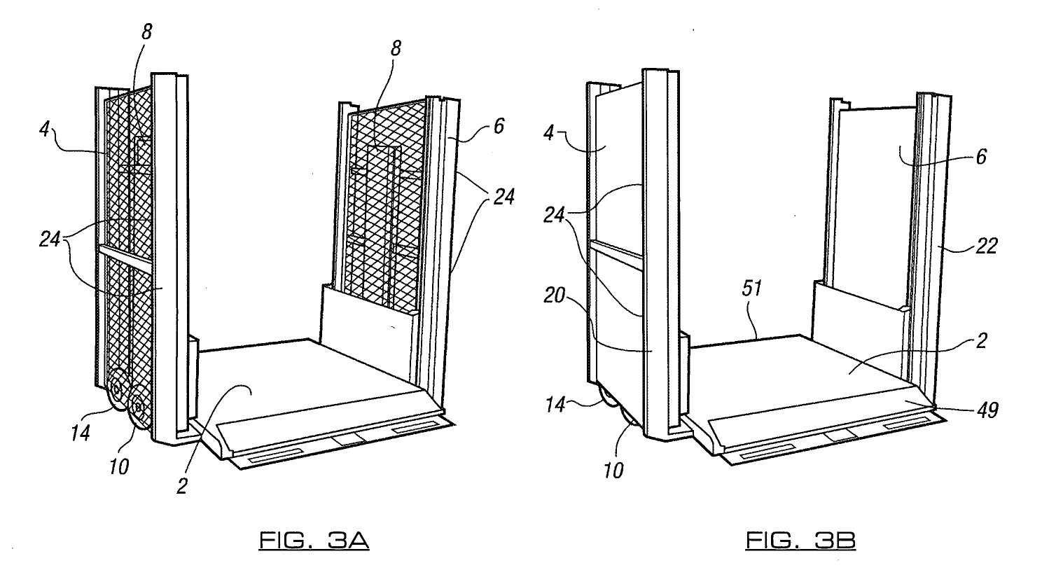

When the platform is lowered it preferably does not lower onto the floor so as to minimise the risk of trapping of feet. The platform does include moveable ramps 49, 51 at each open end of the platform which can be moved to a lowered position as shown in FIGS. 3a-b to allow, for example wheeled trolleys, to be wheeled off and onto the platform.

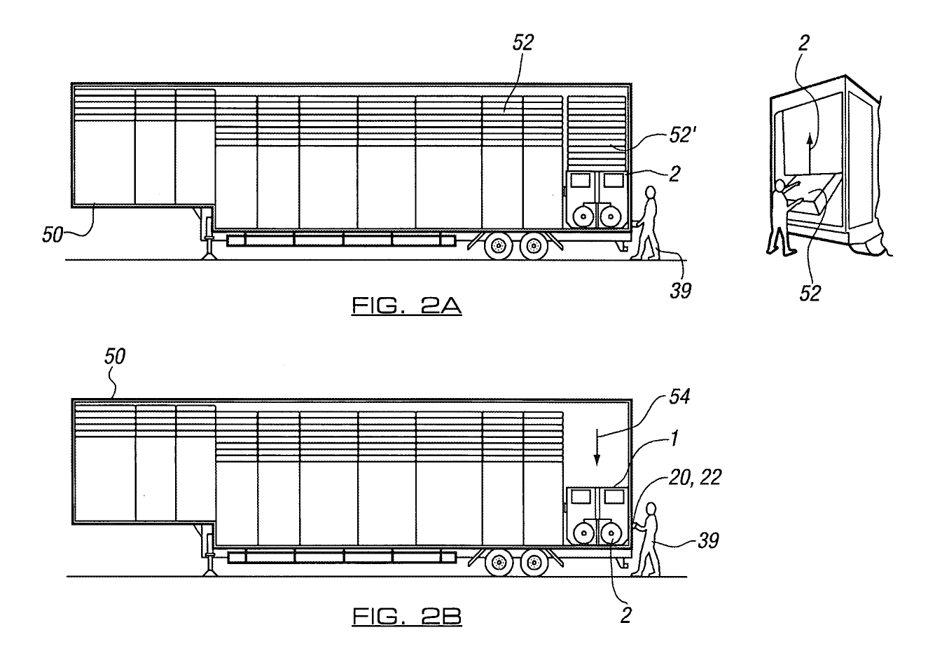

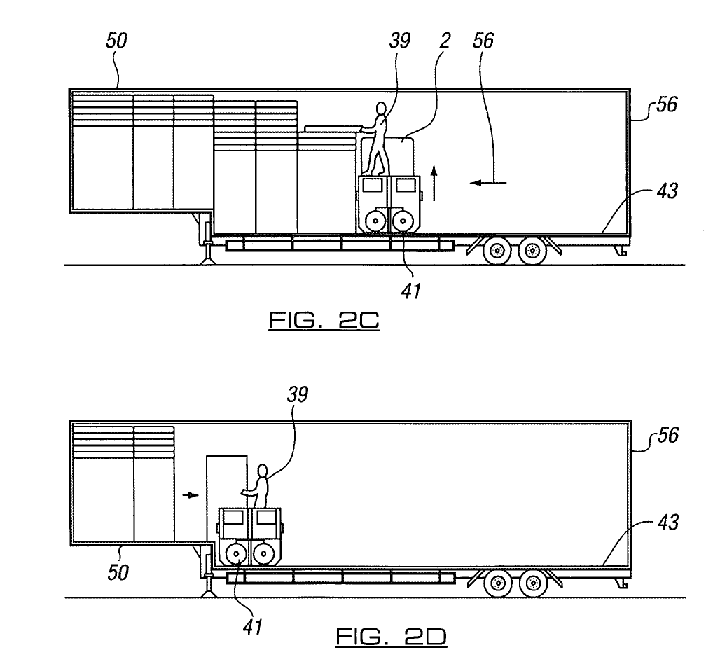

FIGS. 2a-d illustrate the operation of the apparatus in accordance with the invention in conjunction with a goods handling trailer 50 and illustrate how the apparatus can be used wholly within the trailer for added utility while at the same time allowing the provision of the apparatus to be taken out of the trailer and used externally of the same as and when required.

FIG. 2a illustrates a wholly loaded trailer with the side wall of the same removed. In this case, the trailer is loaded with bed units 52. At the location for unloading, the bed units which are loaded underneath the platform 2 of the apparatus are first unloaded as illustrated by the photograph adjacent FIG. 2a and thus it will immediately be appreciated that as there are no parts to the apparatus other than the platform lying between the side walls, the area underneath the platform, where the platform is raised, can be used for storage purposes so that no or minimal storage space is taken up by the provision of the apparatus in accordance with the invention.

With the goods underneath the platform removed, the platform 2 is then lowered down and as it does so, the beds 52′ which are supported by the platform are moved downwardly along with the platform as indicated by arrow 54 in FIG. 2b. These units can also then unloaded. With no beds 52′ left on the platform, the wheels of the apparatus can be powered down to allow the unit to be wheeled into the required position along the length of the goods storage area as indicated by arrow 56 in FIG. 2c. The movement of the wheels 10-16 can be powered with the operator 39 guiding the movement by means of the handles 20, 22 provided on the apparatus. When the required location is reached, the wheels are moved to a retracted position which allows the base 41 of the apparatus 1 to come into contact with the floor 43 of the storage trailer and hence secure the apparatus in a fixed position. The operator can then get onto the platform and raise the platform 2 to the required height so as to allow the operator 39 to reach the bed units 52 to be unloaded and the bed units can be unloaded onto the platform 2 and then the apparatus moved along the length of the goods storage area repeatedly to the opening 56 to allow the unloading function to be achieved.

A further advantage is that as, in the case shown, many goods transport trailers have a stepped portion towards the front end and the apparatus in accordance with the invention allows the operator to move the platform to the same height as the stepped portion of the trailer, therefore allowing improved removal of the goods and loading of goods. It should therefore be appreciated that the steps 2a to 2d can be repeated in reverse to allow the loading of goods to the goods storage trailer.

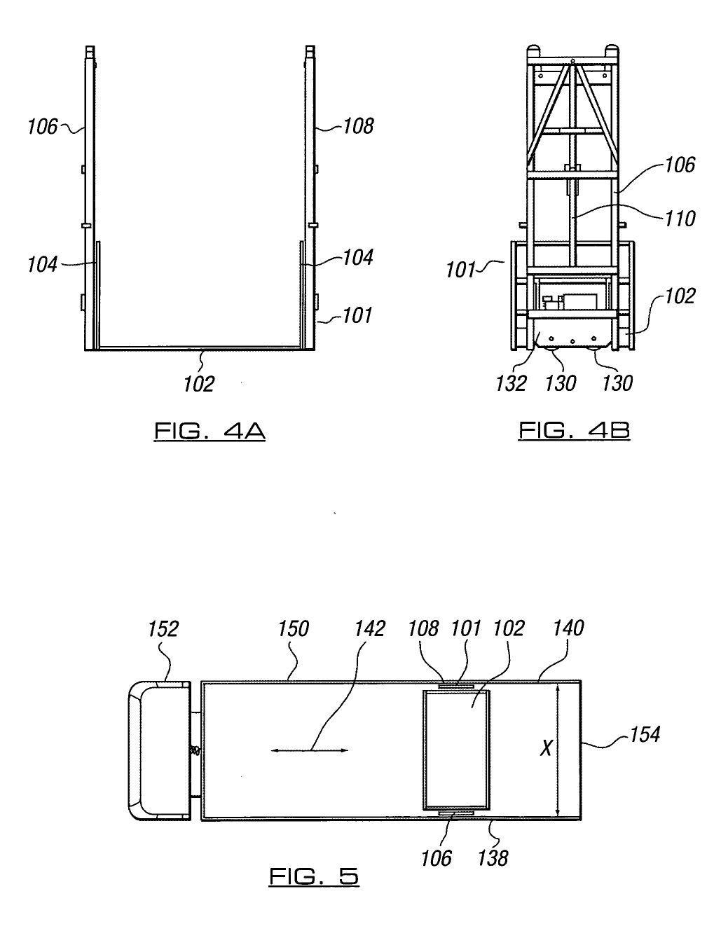

Turning now to FIGS. 4a-d there is illustrated an alternative embodiment of the invention. In this case the apparatus 101 has a platform 102 with side bars 104 which can be received in th side walls 106, 108 in guides (not shown) and which allow the platform and side walls to be kept square and in line. The side walls include a lifting ram 110 connected to claims on which the platform is suspended thereby giving, for example, a 2:1 ratio of lift of the platform.

In this case the wheels 130 are provided, two on one side wall 106 and two on the opposing side walls 108. Each pair of wheels are located on a cartridge 132, which are movable under the influence of a ram 134. When the cartridge is in an in use position the wheels 130 contact the surface or floor of the goods storage area, and the apparatus can be moved about. However when it is desired to move the platform the cartridge and hence wheels are moved to a retracted position which means that the base 136 contacts the floor or surface and hence locks the apparatus in position. In a typical embodiment a mechanical interlock can be provided which ensures that the platform 102 cannot be moved until the wheel cartridges are moved to the retracted position.

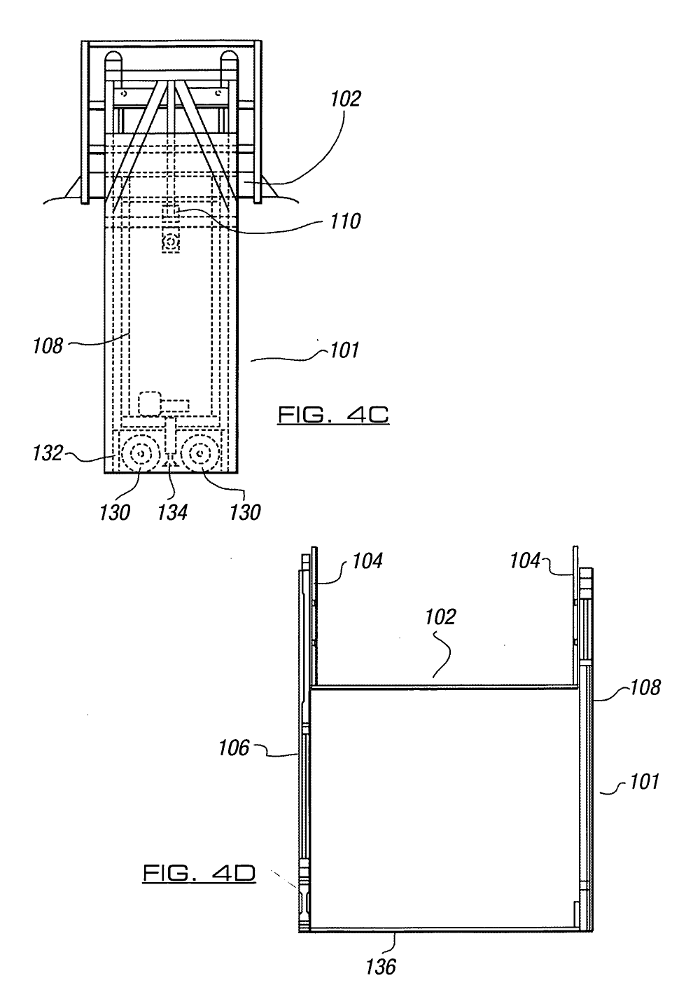

FIG. 5 illustrates a plan view of a goods storage trailer 150, hitched to a tractor unit 52, with the roof removed, to show how the platform 102 and apparatus 101 extends substantially across the width X of the trailer area so that the side walls 106, 108 lie adjacent the interior faces of the respective side walls 138, 140 of the trailer. The apparatus is then capable of movement in the direction indicated by arrow 142 when the wheels are in the in-use position. if required the apparatus 101 can be moved out of the trailer through the opening 154 for use externally of the goods storage area.

The provision of the apparatus in the form herein described allows apparatus to be utilised both within a goods storage trailer and also externally of the same on, for example, a loading dock thus enabling trailers to be loaded or unloaded in safety. The ability for the apparatus to be used separately from the goods storage trailer means that if the apparatus is required to be serviced or there is a failure, the same can be replaced with another of the apparatus so that a continuous loading or unloading facility can be provided. It also means that operators of a large number of trailers with a smaller number of loading docks need not provide movement apparatus in each trailer but rather need only ensure that apparatus in accordance with the invention is available at each loading dock to move in and out of each trailer.

The provision of the wheels directly below the hydraulic workings of the platform enable minimal amount of intrusion of the wheels into the load space. Preferably the wheels are powered to overcome difficulties of using the equipment on uneven surfaces and/or slopes.

The apparatus can also be used inside and in conjunction with goods storage areas which have fixed side walls or curtain sided side walls and can pass through side doors on both sides of vans, and therefore can be used in any trailer without the trailer having to be “bespoke” or specially adapted. This therefore means that, for example, rental companies can keep the apparatus separate from the trailers and send the same out to customers who require the apparatus and allows companies with existing fleets of trailers to immediately utilise the apparatus in accordance with the invention without the need to adapt their trailer fleet.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention

1. An apparatus for use in the movement of goods between first and second locations in a goods handling area or areas comprising a body with at least one platform movable in a substantial vertical direction, a drive means for driving movement of the platform, said drive means and/or guide means acting as a guide for the movement of the platform, and wheels or rollers provided to allow movement of the apparatus across the floor of the goods storage area, the goods storage area including the interior of a goods storage trailer thereby allowing goods to be moved from an external location to within the trailer and/or within the trailer via said apparatus and wherein the platform extends substantially across the width of the interior of the goods storage trailer.

2. The apparatus of claim 1 wherein when the apparatus is positioned within the vehicle trailer the side walls of the body of the apparatus lie adjacent to the respective side walls of the goods storage trailer.

3. The apparatus of claim 1 wherein the width of the apparatus is less than the width of the opening into the goods storage trailer.

4. The apparatus of claim 1 wherein the side walls or faces of the apparatus are provided with members which are provided to contact with side walls of the goods storage trailer during movement of the apparatus along the same.

5. The apparatus of claim 4 wherein the members extend outwardly from the side walls of the apparatus.

6. The apparatus of claim 5 wherein the members are rollers or skids.

7. The apparatus of claim 1 wherein movement of the apparatus when in the goods storage trailer is substantially confined to a direction along the longitudinal axis of the storage area.

8. The apparatus of claim 1 wherein the wheels of the apparatus are located on the side walls of the apparatus.

9. The apparatus of claim 1 wherein at least one of the wheels is connected to a drive motor to provide powered movement of the apparatus along the goods storage area floor.

10. The apparatus of claim 9 wherein an operator of the apparatus can control movement of the same across the goods storage area floor and movement of the platform via common control means connected to control the drive motor and drive means operation respectively.

11. The apparatus of claim 1 wherein the apparatus is operable in two user selectable modes, a first mode where the wheels are fixed to move along a linear path and a second mode wherein at least some of the wheels are pivotal to allow steerage.

12. The apparatus of claim 11 wherein the apparatus is provided in the first mode when located in the goods storage trailer.

13. The apparatus of claim 11 wherein the change between operating modes is achieved by the engagement of locks on those wheels which are pivotable, for the first mode, and release of the locks for the second mode.

14. The apparatus of claim 1 wherein the side walls of the apparatus incorporate therein drive means connected to the platform.

15. The apparatus of claim 1 wherein the goods storage trailer has rigid side walls.

16. The apparatus of claim 1 wherein the goods storage trailer has side walls formed by flexible curtains of material which can be selectively moved between an open position and a closed position.

17. The apparatus of claim 1 wherein the wheels are movable between an in use position in which the same contact with the goods storage area floor to allow movement of the apparatus, and a retracted position, in which the underside of the body of the apparatus contacts the floor to act to retain the apparatus in position.

18. The apparatus of claim 17 wherein the wheels are mounted on cartridges which in turn are mounted on the body of the apparatus, with the cartridge movable with respect to the apparatus body between in use and retracted positions.

19. The apparatus of claim 17 wherein the platform cannot be moved on the apparatus until the wheels are moved to the retracted position.

20. The apparatus of claim 1 wherein the apparatus is a self contained unit within the goods storage trailer.
